(19) United States
(12) Patent Application Publication
(10) Pub. No.: US 2019/0048205 A1
(43) Pub. Date: Feb. 14, 2019

(54) ADHESION PREVENTING FILM

(71) Applicant: OLYMPUS CORPORATION, Tokyo (JP)

(72) Inventors: Hiroaki KASAI, Tokyo (JP); Takeshi DEGUCHI, Tokyo (JP); Takuya FUJIHARA, Tokyo (JP)

(73) Assignee: OLYMPUS CORPORATION, Hachioji-shi, Tokyo (JP)

(21) Appl. No.: 16/164,239

(22) Filed: Oct. 18, 2018

Related U.S. Application Data
(63) Continuation of application No. PCT/JP2017/015302, filed on Apr. 14, 2017.

(30) Foreign Application Priority Data
Apr. 20, 2016 (JP) 2016-084625

(51) Int. Cl. C09D 5/00; C09D 183/04; C09D 7/62; C09D 7/40

(52) U.S. Cl. CPC C09D 5/00; C09D 183/04; C08K 3/36; C09D 7/70; C09D 7/62

(57) ABSTRACT

An adhesion preventing film coated on a surface of a member, includes a surface layer with siloxane bonding as a main component; and protrusion particles, each protrusion particle having a protrusion part protruding from the surface layer, wherein a methyl group exists at least on a surface of the protrusion part of the protrusion particle.

This application is a continuation application of a PCT International Application No. PCT/JP2017/015302, filed on Apr. 14, 2017, whose priority is claimed on a Japanese Patent Application No. 2016-084625, filed on Apr. 20, 2016. The contents of both the PCT International Application and the Japanese patent application are incorporated herein by reference.

### BACKGROUND OF THE INVENTION

### Field of the Invention

This invention relates to an adhesion preventing film configured to prevent a substance from adhering on a surface.

### Description of Related Art

When a medical device is used, there is a case in which an adhesion preventing film is coated on a surface of the medical device for suppressing adhesion of living substances on the surface of the medical device. For example, there is a case when a medical device configured to generate heat while being used, such as a high-frequency knife or a heat probe and the like is used, a protein component of the living substances adhered to the medical device is denaturized in high temperature such that the adhesion of the living substances become firm. A water repellent coating in Japanese Unexamined Patent Application, First Publication No. 2000-26844 is disclosed as an example of an adhesion preventing film.

In Japanese Unexamined Patent Application, First Publication No. 2000-26844, it is disclosed that a water repellent coating paint including either of fluororesin powder or inorganic powder with a surface being processed by a hydrophobization process or mixture powder mixed by several types of powder, a silicone resin binder, and either of silicone oil or fluorosilicone oil or a mixture oil mixed by several types of oil is coated on a member for preventing the member from being covered by ice.

### SUMMARY OF THE INVENTION

According to a first aspect of the present invention, an adhesion preventing film being coated on a surface of a member or a part of a device includes a surface layer with siloxane bonding as a main component; and protrusion particles, each protrusion particle having a protrusion part protruding from the surface layer, wherein a methyl group exists at least on a surface of the protrusion part of the protrusion particle.

According to a second aspect of the present invention, in the adhesion preventing film according to the first aspect, polydimethylsiloxane may be coated on the surface of the protrusion part of the protrusion particle.

According to a third aspect of the present invention, in the adhesion preventing film according to the first aspect or the second aspect, the protrusion particle may be silica particles, and the methyl group may be directly bonded to the silica particles.

According to a fourth aspect of the present invention, in the adhesion preventing film according to any of the first aspect to the third aspect, intervals among the protrusion particles on a surface of the surface layer may be coated by a hydrophilic group.

According to a fifth aspect of the present invention, the adhesion preventing film according to any of the first aspect to the fourth aspect may further have an intermediate layer formed under the surface layer, wherein a filler may be diffused in the intermediate layer.

According to a sixth aspect of the present invention, in the adhesion preventing film according to any of the first aspect to the fifth aspect, the protrusion particles may be hollow particles having a hollow cavity formed inside.

### BRIEF DESCRIPTION OF DRAWING

FIG. 1 is a schematic cross-sectional view showing an adhesion preventing film according to a first aspect of the present invention.

FIG. 2 is a schematic view showing a medical device being coated by the adhesion preventing film according to the first aspect of the present invention.

FIG. 3 is a schematic cross-sectional view showing an adhesion preventing film according to a second aspect of the present invention.

FIG. 4 is a schematic cross-sectional view showing an adhesion preventing film according to a third aspect of the present invention.

FIG. 5 is a schematic view showing a medical device being coated by the adhesion preventing film according to the third aspect of the present invention.

FIG. 6 is a schematic cross-sectional view showing an adhesion preventing film according to a fourth aspect of the present invention.

FIG. 7 is a schematic cross-sectional view showing an adhesion preventing film according to a fifth aspect of the present invention.

### DETAILED DESCRIPTION OF THE INVENTION

### First Embodiment

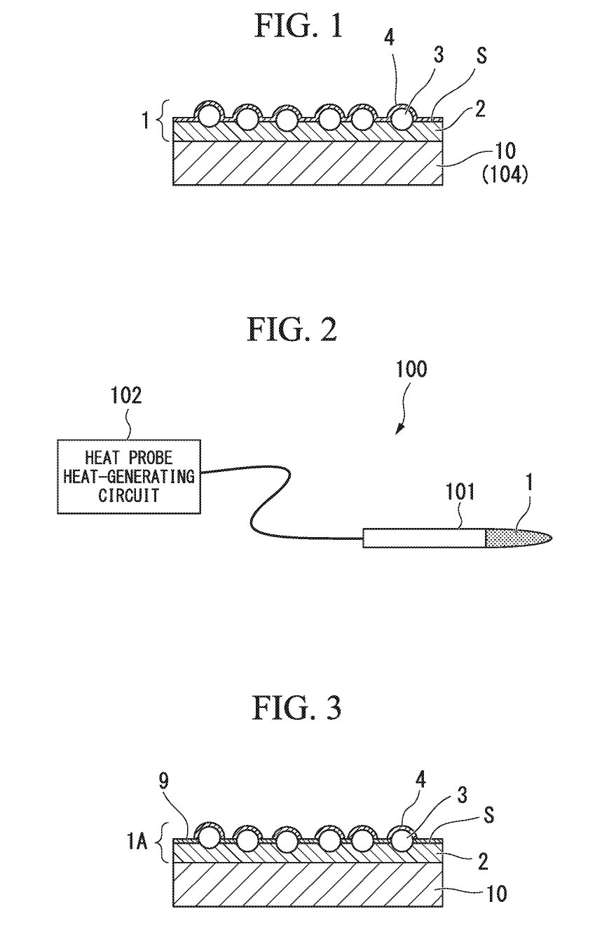

An adhesion preventing film according to the present embodiment will be described by referring to FIGS. 1 and 2.

An adhesion preventing film 1 according to the first embodiment is coated on a surface of a member. FIG. 1 is a schematic cross-sectional view showing an adhesion preventing film 1 according to the present embodiment, showing a state in which the adhesion preventing film 1 is formed on a surface of a stainless member 10. The stainless member 10 has only to be formed in a shape such that the adhesion preventing film 1 can come in close contact with the stainless member 10, and the shape of the stainless member 10 is not particularly limited. The shape of the stainless member 10 may be a plane surface, or a curved surface. In order to cause the adhesion preventing film 1 to contact with the surface of the member 10 more securely, the surface of the member 10 may be a rough surface. Also, in order to make the member 10 and the adhesion preventing film 1 to come in close contact with each other, a layer formed by a silane coupling agent may be formed on a boundary of the member 10 and the adhesion preventing film 1.

The adhesion preventing film 1 according to the present embodiment has a surface layer 2 and protrusion particles 3 protruding from a surface S of the surface layer 2. The protrusion particles 3 are maintained on the surface layer 2. The adhesion preventing film 1 according to the present embodiment is configured by a single layer. Accordingly, the surface layer 2 comes in close contact with the surface of the member 10, and the surface layer 2 is configured to be on the surface of the adhesion preventing film 1.

The surface layer 2 is configured to have siloxane bonding as a main component. A material having the siloxane bonding as a main component can be selected from any of an organic material called a silicone, an inorganic material such as an inorganic silica or the like, and an organic-inorganic hybrid material.

When the silicone is used as the composition material of the surface layer 2, it is difficult for the surface layer to crack so as to improve impact resistance, even if the surface layer is formed to be thick.

When the inorganic silica is used as the composition material of the surface layer 2, thermal resistance and endurance can be achieved in a high level.

When the organic-inorganic hybrid material is used as the composition material of the surface layer 2, a superior balance among the thermal resistance, the impact resistance, and the endurance can be achieved on the surface layer 2.

In the material having the siloxane bonding as the main component, since the thermal resistance can be improved, it is preferable to include more inorganic material such as the silica and the silicone resin.

A part of each protrusion particle 3 protrudes from the surface S of the surface layer 2 so as to form an uneven shape on the surface S of the adhesion preventing film 1. A methyl-group containing layer 4 described below is provided on the surface of the protrusion particles 3 exposed to the outside of the surface layer 2.

Any of spherical particles, flaked particles, and agglomerated particles formed by agglomeration of particles may be used as the protrusion particles 3. However, there is a case in which the anchor effect is generated to degrade the adhesion preventing performance when the protrusion part protruded from the surface S of the surface layer 2 is formed in an acute-angle shape, it is preferable that the protrusion particles 3 are formed in an approximately spherical shape.

A material of the protrusion particle 3 only needs to have the thermal resistance and is not particularly limited.

For example, a silica (hydrophilic), an inorganic ceramic material such as an alumina or a zirconia, a hydrophobic group modified silica, an aluminum nitride, and a hollow silica can be considered.

When the hydrophilic silica is used as the material of the protrusion particles 3, it is suitable that the protrusion particles 3 are easy to bond with the surface layer 2 having the siloxane bonding as the main component to achieve the adhesion in a high level.

When the ceramic material such as the alumina or the zirconia is used as the material of the protrusion particles 3, it is easy to control the size. Since particles having a large diameter is easy to obtain, it is suitable in a case in which a thickness of the surface layer 2 is large, and it is suitable in a case in which it is desirable to make a protrusion amount of the protrusion particles 3 protruded from the surface S of the surface layer 2 to be large.

In a case in which a hydrophobic group containing layer described below is formed, it is preferable to use the hydrophobic group modified silica as the material of the protrusion particles 3 in consideration of manufacturing cost.

When the aluminum nitride is used as the material of the protrusion particles 3, since a thermal transmission performance is high, when the adhesion preventing film 1 is formed on a member used in a high temperature, it is possible to rapidly heat the member to improve the treatment performance.

Even among the materials, the silica particles are in the same system with the material of the surface layer 2, it is suitable that the adhesion in a high level can be expected.

In a case in which the portion where the adhesion preventing film 1 is formed is a portion to which it is not necessary to transmit heat, thermal insulation effectiveness can be achieved by using hollow particles having a hollow cavity formed inside as the protrusion particles 3. For example, it is suitable that when the hollow silica particles are adopted as the protrusion particles 3, the thermal insulation effectiveness is improved such that it becomes difficult to transmit the heat of the member 10 as a base material to the adhesion substance and the adhesion preventing effectiveness is furtherly improved. The portion to which it is not necessary to transmit heat refers to a portion where the temperature necessarily rises together with temperature rise of the treatment portion except for the treatment portion of the treatment device, specifically, a peripheral portion of the treatment portion of the heat probe, an electrocautery or a pair of electrical forceps, a peripheral portion of the treatment portion in a high-frequency treatment device, or a rear portion of the treatment portion.

The particle size of the protrusion particles 3 only has to be determined such that an uneven shape is formed on the surface 2 of the surface layer 2, and it is preferable that the particle size of the protrusion particles 3 is equal to or more than the thickness of the surface layer 2 for protruding the protrusion particles 3 from the surface S of the surface layer 2 easily and securely.

When the methyl-group containing layer 4 is configured to bond with the surface S of the surface layer 2 and the surface of the protrusion particles 3 directly, compared with the case in which a film is formed on the surface S of the surface layer 2 and the surface of the protrusion particles 3, a dimensional accuracy in a high level can be achieved. The methyl-group containing layer 4 may be formed to dispose polydimethylsiloxane (PDMS) and the like on the surface S of the surface layer 2 and the surface of the protrusion particles 3. In this case, the endurance can be achieved due to the film thickness of the methyl-group containing layer 4.

Next, a formation method of the material of the adhesion preventing film 1 will be described.

As a formation method of the material having the siloxane bonding for forming the surface layer 2, in a case of using the inorganic materials, a method of hydrolyzing an alkoxysilane (for example, brand name “Glassca”, manufactured by JSR Corporation) to perform the condensation reaction, or curing polysilazane (for example, brand name “AZ inorganic coating agent NL120A”, manufactured by Merck) or methyl silicone resin (for example, brand name “KR-242” and “KR251”, manufactured by Shin-Etsu Chemical Co., Ltd.) by heating can be used.

As a method of forming the uneven shape by the protrusion particles 3 in the surface layer 2, for example, a method of mixing colloidal silica (for example, brand name “Snowtex” manufactured by Nissan Chemical Corporation”, or brand name “Sicastar water dispersion type” manufactured by Micromod) into the alkoxysilane described above, stirring and coating on the heat-generating portion 104, and a method of mixing silica particles (for example, brand name “Sicastar powder type”, manufactured by Micromod) into the polysilazane or the methyl silicone resin described above, coating and curing are taken as examples.

As a method of forming the methyl-group containing layer 4 on the surface S of the surface layer 2 or the surface of the protrusion particles 3, a method of directly bonding the methyl-group by hexamethyldisilazane (HMDS) process or a method of forming a polydimethylsiloxane (PDMS) layer are taken as examples.

As a method of forming the PMDS layer, a method of hydrolyzing and coating dimethyldimethoxysilane (for example, brand name “KBM-22”, manufactured by Shin-Etsu Chemical Co., Ltd.), and then performing the condensation reaction for curing is taken as an example.

Next, a specific formation method of the adhesion preventing film 1 according to the present embodiment will be described.

Firstly, the alkoxysilane (brand name “Glassca” manufactured by JSR Corporation) used for forming the surface layer 2 and the colloidal silica (brand name “Snowtex” manufactured by Nissan Chemical Corporation) are mixed and stirred to manufacture a coating liquid.

Next, the coating liquid is coated on a surface of the member used as the heat-generating portion 104. The coating method is not particularly limited, and a suitable method in accordance with the shape of the coating surface of the heat-generating portion 104 is used. For example, spin coating and spraying are used as the coating method. If necessary, before the coating, blast processing may be performed on the coating surface of the heat-generating portion 104 to rough the coating surface.

After the coating liquid is coated, curing is performed by heating. Accordingly, the hydrolyzation reaction and condensation reaction are progressed such that the alkoxysilane is cross-linked and solidified. The silica particles obtained from the colloidal silica protrudes from the solidified surface layer 2 to form the uneven shape on the surface S of the surface layer 2. At this time, the thickness of the adhesion preventing film 1 and the size of the protrusion particles 3 are appropriately adjusted such that the protrusion particles 3 protrudes from the surface S of the surface layer 2 to form the uneven shape on the surface S.

Next, surface processing is performed. The member 10 used as the heat-generating portion 104 is put into a heating chamber. Also, HMDS contained in a dish is put into the same heating chamber. When the heating chamber is heated, the MHDS in the dish is evaporated. The evaporated HMDS reacts with the silanol-group (Si—OH) on the surface of the surface layer 2 and the protrusion particles 3 to form the methyl-group on the surface to achieve the hydrophobic. Thus, the adhesion preventing film 1 is manufactured.

In a case in which the silane coupling agent is used for improving the adhesion, it is possible to adopt a method of coating it on the surface of the member 10 and drying it in advance, or a method of mixing it with the material used as the coating liquid and coating it, and the like.

Next, an application of the adhesion preventing film 1 will be described. FIG. 2 is a schematic view showing an example of a medical device 100 on which the adhesion preventing film 1 is provided.

The medical device 100 shown in FIG. 2 is a heat probe having a heat-generating circuit 102, a heat probe main body 103, and a heat-generating portion 104 disposed at a distal end thereof. A heat-generating diode (not shown) configured to generate heat due to a direct current is incorporated inside the heat-generating portion 104 such that the heat-generating portion 104 is configured to generate heat by an electric current supplied by the heat-generating circuit 102. The adhesion preventing film 1 according to the present embodiment is formed on the surface of the heat-generating portion 104.

Since the adhesion preventing film 1 according to the present embodiment is formed such that the protrusion particles 3 protrude from the surface S to form the uneven shape, a rough surface is formed on the surface of the member 10, wettability with respect to the liquid can be reduced, and adhesion preventing performance with respect to the living substance on the portion which contacts with the living body to heat the living body can be improved. Accordingly, it is possible to improve the adhesion preventing performance with respect to the living substance when used in the medical device configured to treat in a high temperature such as the heat probe.

Since the adhesion preventing film 1 according to the present embodiment is configured such that the protrusion particles 3 is exposed from the surface S of the surface layer 2 and whole of the surface of the adhesion preventing film 1 is covered by the hydrophobic group, it is possible to improve the water repellency performance of the surface layer 2. As a result, since the adhesion preventing performance of the member 10 with respect to the living tissues can be improved, in a case in which it is used in the medical device performing treatment in a high temperature, it is difficult for the living tissues to come in close contact. Accordingly, for example, it is possible to improve the adhesion preventing performance of the medical device configured to perform hemostasis and coagulate tissues by contacting the heat-generating portion 104 in a high temperature state with the living tissues.

### Second Embodiment

Next, an adhesion preventing film 1A according to a second embodiment of the present invention will be described in accordance with FIG. 3.

FIG. 3 is a schematic cross-sectional view showing a configuration of the adhesion preventing film 1A according to the present embodiment. As shown in FIG. 3, in the adhesion preventing film 1A according to the present embodiment, the methyl-group containing layer 4 is formed only on the surface of the protrusion particles 3, and a hydrophilic layer 9 is formed on the other surface S of the surface layer 2.

A coating liquid is manufactured by mixing the hydrophobic silica particle powder (brand name “Sicastar powder trimethylsilyl-group modified type” manufactured by Micromod) into the polysilazane (brand name “AZ inorganic coating agent NL120A” manufactured by Merck) configured to form the surface layer 2. Next, this coating liquid is coated on the surface of the member 10 which is used as the heat-generating portion 104.

After the coating of the coating liquid, heating and curing are performed. Accordingly, the polysilazane reacts with the water in the air to proceed the deammoniation reaction such that the coating film changes into a silica film. Since the hydrophilic group is exposed on the surface of the silica film, the silica film becomes hydrophilic. On the other hand, the surface of the part protruding from the surface S of the surface layer 2 of the protrusion particle 3 is modified by the methyl-group so as to be hydrophobic. As described above, the adhesion preventing film 1A is formed.

According to the adhesion preventing film 1A of the present embodiment, similar to the first embodiment, it is possible to improve the adhesion preventing performance of the medical device configured to perform hemostasis and coagulate tissues by contacting the heat-generating portion 104 in a high temperature state with the living tissues.

According to the adhesion preventing film 1A of the present embodiment, since the surface S of the surface layer 2 is hydrophilic, water inside the living body adheres to the surface S of the surface layer 2. Accordingly, it becomes difficult for the surface S of the surface layer 2 to directly contact with the living tissues, and a contact area between the surface of the adhesion preventing film 1A and the surface of the living tissues decreases. Additionally, when the water adhered to the surface S of the surface layer 2 is evaporated due to the heat of the heat-generating portion 104, a force of peeling the living tissues applies such that the adhesion preventing performance is improved.

### Third Embodiment

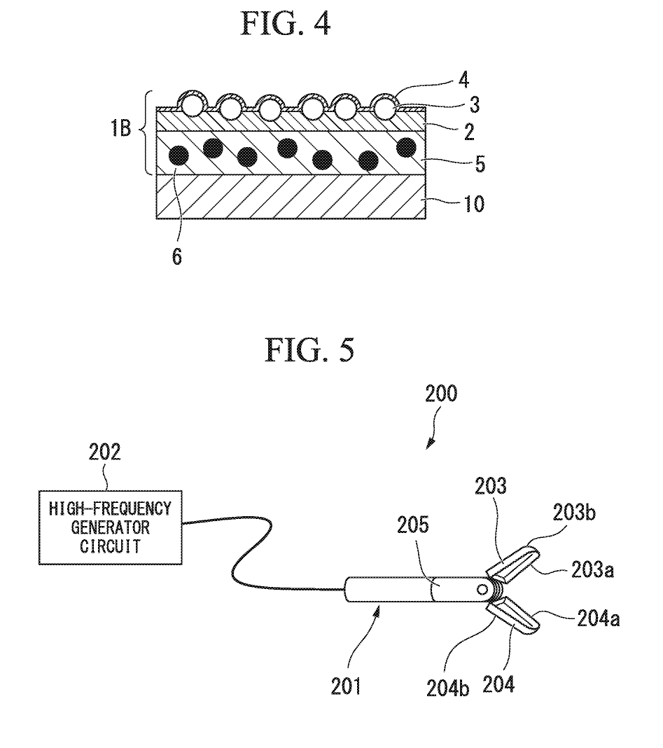

Next, an adhesion preventing film 1B according to a third embodiment of the present invention will be described in accordance with FIG. 4.

As shown in FIG. 4, the adhesion preventing film 1B according to the present embodiment is different from the first embodiment in that an intermediate layer 5 is provided between the surface layer 2 and the member 10.

Examples of the intermediate layer 5 can be thermal insulated materials such as the organic materials having a small thermal transmittance. For example, when the intermediate layer 5 is formed by a resin material having a heat resistance in a high level, such as Polybenzimidazole (PBI), Polyimide (PI), polyether ether ketone (PEEK), since heat insulation is superior even if in a high temperature, it is suitable to prevent unnecessary temperature rise of the desired member. Particularly, when the intermediate layer 5 is formed by a soft silicone rubber, besides the high heat insulation performance, it becomes easy to absorb the difference of the thermal expansion coefficient between the base material and the intermediate layer 5 such that it is possible to make the adhesion preventing film 1B to be thick and it is superior in the heat resistance and electric insulation. Such an intermediate layer 5, for example, is suitably applied in the forming of an adhesion preventing film on a portion where the temperature necessarily rises together with temperature rise of the treatment portion. Other than the treatment portion of the treatment device, such a portion includes specifically, a peripheral portion of the treatment portion of the heat probe, an electrocautery or a pair of electrical forceps, a peripheral portion of the treatment portion in a high-frequency treatment device, or a rear portion of the treatment portion.

The intermediate layer 5 may have a filler 6. The adhesion preventing film 1B according to the present embodiment is configured to have the filler 6 filled in whole of the intermediate layer 5. The filler 6, for example, may have the same configuration with the protrusion particles 3. When particles having the same configuration of the protrusion particles 3 are used as the filler 6, in the case in which the adhesion preventing film 1B is formed to be thick, it is possible to prevent the adhesion preventing film 1B from cracking.

Further, the hydrophilic silica or pigment may be used as the filler 6. When the hydrophilic silica is used as the filler 6, it is suitable since the adhesion with the intermediate layer 5 is improved. In a case of forming the adhesion preventing film 1B on a member to achieve a desired heat insulation performance, it is preferable to use hollow hydrophilic silica particles as the filler for improving the heat insulation performance. When the pigment is used as the filler 6, it is possible to color the member and improve the adhesion with the intermediate layer 5.

For example, when an inorganic pigment having an average diameter of 5 micrometers is mixed into a silica layer with a thickness of 10 micrometers, it is possible to reduce an amount of the silica in the intermediate layer 5 and to reduce a displaced amount of an expansion amount or a shrinkage amount due to the heat of the member 10 . As a result, even if the adhesion preventing film is formed to be thick, it can prevent the adhesion preventing film from cracking due to the difference of the thermal expansion coefficient between the member 10 and the intermediate layer 5.

Next, an application of the adhesion preventing film 1B will be described. FIG. 5 is a schematic view showing an example of the medical device 200 being processed by the adhesion preventing film 1B. The medical device 200 shown in FIG. 5 is a pair of high-frequency hemostasis forceps, having a high-frequency generation circuit 202 and a treatment portion 201 disposed at a distal end thereof. The treatment portion 201 has a forceps main body 205 and a pair of forceps 203, 204. The pair of forceps 203, 204 is the portion mainly performing the treatment, particularly conductive portions 203a, 204a grasping the living tissues are configured to flow a current to the living tissues to heat the living tissues and perform hemostasis and coagulation to the living tissues. Accordingly, the conductive portions 203a, 204a are needed to be conductive. On the other hand, since outward portions 203b, 204b of the forceps 203, 204, respectively are portions configured not to directly perform the treatment, the outward portions 203b, 204b are insulative to not to flow the current . However, when the conductive portions 203a, 204a are heated, due to the heat transmission, the temperature of the outward portions 203b, 204b of the forceps 203, 204 rises. At this time, in order to prevent the tissues in the vicinity of the forceps 203, 204 from being coagulated, it is preferable that the temperature of the insulation portions of the outward portions 203b, 204b do not rise as much as possible.

In this case, the configuration of the adhesion preventing film on the conductive portions 203a, 204a, and the outward portions 203b, 204b may be changed. That is, similar to the adhesion preventing film 1 according to the first embodiment, adhesion preventing film having a single-layer film with the protrusion particles 3 (for example, aluminum nitride with hydrophobic coating) may be formed on the conductive portions 203a, 204a, and adhesion preventing film 1B according to the present embodiment may be formed on the outward portions 203b, 204b.

On the other hand, similar to the usage of the heat probe, there is a case in which the forceps 203, 204 are energized in a closed state to be heated, and the temperature of the insulation portions of the outward portions 203b, 204b of the forceps 203, 204 rises. In a case in which the forceps 203, 204 are used in this way, it is preferable that the temperature of the outward portions 203b, 204b smoothly rises in accordance with the heating of the conductive portions 203a, 204a. In this case, the adhesion preventing film 1 according to the first embodiment may be formed on whole of the forceps 203, 204.

According to the adhesion preventing film 1B according to the present embodiment, similar to the first embodiment, it is possible to improve the adhesion preventing performance with respect to the living substance in the medical device configured to perform hemostasis and coagulate tissues by contacting the conductive portions 203a, 204a in a high temperature state with the living tissues.

Further, according to the adhesion preventing film 1B according to the present embodiment, the intermediate layer 5 having the filler 6 may be configured such that it is possible to make the adhesion preventing film to be thick, and it is suitable for the adhesion preventing film 1B used in a member required for heat insulation and electric insulation performance.

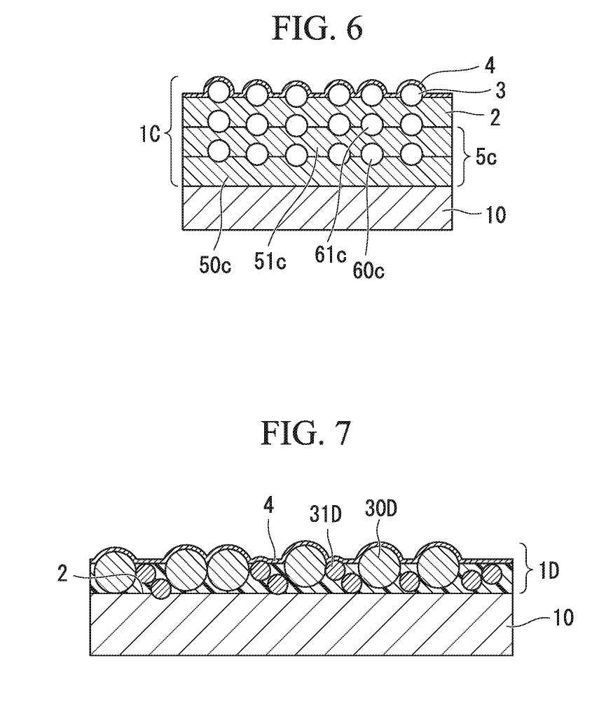

Next, a modification of the adhesion preventing film 1B according to the third embodiment of the present invention will be described in accordance with FIG. 6.

As shown in FIG. 6, the adhesion preventing film 1C of the present modification is different with that of the third embodiment in the configuration of the intermediate layer. The intermediate layer 5C according to the present modification is configured to have three layers, wherein each has same configuration as the surface layer 2 according to the first embodiment. That is, by the same formation method of the adhesion preventing film 1 according to the first embodiment, a first layer 50c formed by a material having the siloxane bonding as the main component is formed on the surface of the member 10, and the particles same as the protrusion particles 3 are provided as the filler 60c. After an enough cooling-off, a second layer 51c formed by the material having the siloxane bonding as the main component is formed above the first layer 50c by the same formation method of the first layer 50c, and the particles same as the protrusion particles 3 are provided as the filler 61c. Further, the adhesion preventing film 1C is achieved by forming the surface layer 2 and the protrusion particles 3 by the same method of the surface layer 2 according to the first embodiment and forming the methyl-group containing layer 4 having the methyl-group on the surfaces of both of the surface layer 2 and the protrusion particles 3.

According to the adhesion preventing film 1C of the present embodiment, similar to the first embodiment, it is possible to improve the adhesion preventing performance with respect to the living substance even used in the medical device configured to perform hemostasis and coagulate tissues by contacting the conductive portions 203a, 204a in a high temperature state with the living tissues.

Further, according to the adhesion preventing film 1C according to the first embodiment, the intermediate layer 5C having the fillers 60c, 61c is provided such that it is possible to make the adhesion preventing film 1C to be thick and it is suitable to be used as the adhesion preventing film of the member required for heat insulation and electric insulation performance. In the case in which the surface of the adhesion preventing film 1C is scraped since the usage times increase, the surface same as the surface layer 2 is exposed such that the performance of the adhesion preventing film can be maintained and the endurance can be improved. The intermediate layer 5C and the fillers 60c, 61c have the same configurations as that of the surface layer 2 and the protrusion particles 3 respectively such that the adhesion performance between the layers is superior. Further, it is possible to diffuse the fillers 60, 61 in the thickness direction of the intermediate layer 5C uniformly.

### Fourth Embodiment

Next, a modification of an adhesion preventing film 1D according to a fourth aspect of the present invention will be described in accordance with FIG. 7.

As shown in FIG. 7, the adhesion preventing film 1D according to the present modification is different from the first embodiment in the configuration of the protrusion particles. The adhesion preventing film 1D according to the present embodiment has protrusion particles 30D, 31D being mixed by particles having different diameters. The protrusion particles 30D, 31D are formed by mixing aluminum nitride particles with different average diameters of 1 micrometer and 20 micrometers. In the adhesion preventing film 1D, the surface layer 2 is formed to have a thickness from 15 micrometers to 18 micrometers by the same method as the first embodiment, and the protrusion particles 30D, 31D having different diameters are diffused therein. In the adhesion preventing film 1D, the protrusion particles 30D having the average diameter of 20 micrometers are configured for forming the uneven shape on the surface S of the surface layer 2 and improving the heat transmission. The protrusion particles 31D having the average diameter of 1 micro meter is diffused among the protrusion particles 30D having the average diameter of 20 micrometers such that a density of the aluminum nitride in the surface layer 2 can be increased, the heat transmission performance is improved, and the temperature of the member 10 can be efficiently increased.

### EXAMPLES

### Example 1

An adhesion preventing film having a single-layer film formed from the silicone rubber and methyl-group modified silica particles as the protrusion particles was formed on a surface of the heat-generating portion 104 of the heat probe.

Specifically, the adhesion preventing film was formed by the following method. As the protrusion particles 3, silica particles (brand name “Sicastar trimethylsilyl-group modified type” manufactured by Micromod) with a diameter of 15 micrometers were mixed into a liquid silicone rubber (brand name KE-3423 manufactured by Shin-Etsu Chemical Co., Ltd.) and sufficiently stirred so as to manufacture a coating liquid. A stainless member 10 of the heat-generating portion 104 which is attached to a rotating chuck was immersed in the coating liquid, then the member 10 is rotated by 3000 revolutions by minutes (RPM) after being lift up. Accordingly, unnecessary coating liquid is removed and a coating film with a thickness of approximately 10 micrometers is formed. Then, a thermosetting treatment is performed by 80 degrees Celsius for 12 hours.

As a result, an adhesion preventing film was obtained on the member 10 of the heat-generating portion 104. The adhesion preventing film includes protrusion particles 3 protruding from the surface S of the surface layer 2 which is a single-layer film of almost 10 micrometer thickness formed by the silicone rubber, and a methyl-group-containing layer 4 having the methyl-group which was formed on the surface of both of the surface layer 2 and the protrusion particles 3.

When the surface of the obtained adhesion preventing film was observed and analyzed by a laser microscope, in a 200 micrometers square area, eight particles existed and the surface roughness was Ra 2.58 micrometers.

The heat-generating portion 104 on which the adhesion preventing film was formed was attached to the heat probe, and current was provided to the heat probe to heat the heat-generating portion 104 by 200 degrees Celsius. The amount of heat was set in a general treatment, however, for the evaluation in the present experiment, the control was performed by setting the temperature and the time. The heated heat-generating portion 104 contacted with a piece of liver of a pig that is cut off as a specimen. The temperature of the living tissues on the contact surface of the heat-generating portion 104 and the liver of the pig rose and coagulation of the tissues occurred. However, since the adhesion preventing film of the Example 1 having the hydrophobic uneven shape was formed on the surface of the heat-generating portion 104, the adhesion of the living substance was almost not confirmed, and it was easy to peel the living substance even if the living substance was adhered on the surface of the heat-generating portion 104. The performance of the adhesion preventing film was maintained even if the same experiment was performed when the heat-generating portion 104 was heated by 400 degrees Celsius. Since the time when the current was provided to the medical device was significantly short, even if the surface layer 2 is made of silicone rubber, the adhesion performance between the member 10 and the surface layer 2 was not lost and enough adhesion preventing effect was achieved.

### Example 2

An adhesion preventing film having a single-layer film formed from the silica and the silica particles as the protrusion particles was formed on the surface of the heat-generating portion 104 of the heat probe.

Specifically, the adhesion preventing film was formed by the following method. The silica particles having a diameter of 10 micrometer and being not modified by the methyl-group (brand name Sicastar without modified manufactured by Micromod) were mixed into the polysilazane (brand name AZ inorganic coating agent NL120A manufactured by Merck) and sufficiently stirred to manufacture a coating liquid.

The coating liquid was coated on the member 10 of the heat-generating portion 104 attached to a fixing jig by spraying. Subsequently, the thermosetting process was performed at approximately 250 degrees Celsius for one hour, and a silica layer having a film thickness of approximately 6 micro meters and having the uneven surface due to the silica particles was formed.

Next, the member 10 after the formation of the silica layer was fixed in an HMDS processing apparatus . In the HMDS processing apparatus, a schale in which the hexamethyldisiloxane (brand name HDMS SZ-31 manufactured by Shin-Etsu Chemical Co. Ltd.) was contained was disposed on a hot-plate in a processing box thereof. As a result of heating the hot-plate by 200 degrees Celsius, HMDS was evaporated and the evaporated HMDS reacted with the OH-group on the surface of the silica layer formed on the surface of the member 10 such that the surface was trimethylsilylated. As a result, the adhesion preventing film with the surface of the silica layer and the surface of the silica particles being covered by the methyl-group due to the methyl-group-containing layer was formed.

As a result of performing the experiment same as the Example 1, the adhesion of the living substance after the temperature of the heat-generating portion 104 was risen was almost not confirmed, and it was easy to peel the living substance even if the living substance was adhered on the surface of the heat-generating portion 104. The same result was obtained when the temperature of the heat-generating portion 104 was increased to 400 degrees Celsius and the same test was performed.

Since the protrusion particles 3 were exposed from the surface S of the surface layer 2 to form the uneven shape and the whole surface S was covered by the hydrophobic group, the adhesion preventing performance with respect to the living tissues was improved even if used in the medical device configured to treat in a high temperature. The whole surface layer 2 was formed by the inorganic silica such that the hardness was high and the scratch resistance was high.

### Comparison Example 1

The adhesive preventing film was not formed on the member 10 of the heat-generating portion 104 which was formed by the stainless steel. As same as the Example 1, the heat-generating portion 104 of the heat probe was heated by 200 degrees Celsius, and the heated heat-generating portion 104 contacted with a piece of liver of a pig that was cut off as a specimen. The living substance being thermal denaturalized adhered to the surface of the heat-generating portion 104 and it was difficult to peel the living substance.

### Comparison Example 2

A film formed by a silica layer only with a thickness of 6 micrometers was formed on the member 10 of the heat-generating portion 104 which was made by the stainless steel. As same as the Example 1, the heat-generating portion 104 of the heat probe was heated by 200 degrees Celsius such that the film cracked due to the difference between the thermal expansion coefficients of the member 10 and the film.

According to the above description, it was shown that the adhesion preventing performance in either of the Example 1 or the Example 2 was high. On the other hand, in the Comparison Example 1, adhesion of the living tissues to the member 10 was confirmed.

The embodiments of the invention have been described above with reference to the drawings, but specific structures of the invention are not limited to the embodiments and may include various modifications without departing from the scope of the invention. The invention is not limited to the above-mentioned embodiments and is limited only by the accompanying claims.

What is claimed is:

1. An adhesion preventing film coated on a surface of a member, comprising:
a surface layer with siloxane bonding as a main component; and
protrusion particles, each protrusion particle having a protrusion part protruding from the surface layer,
wherein a methyl group exists at least on a surface of the protrusion part of the protrusion particle.

2. The adhesion preventing film according to claim 1, wherein polydimethylsiloxane is coated on the surface of the protrusion part of the protrusion particle.

3. The adhesion preventing film according to claim 1, wherein the protrusion particle are silica particles, and the methyl group is directly bonded to the silica particles.

4. The adhesion preventing film according to claim 1, wherein intervals among the protrusion particles on a surface of the surface layer are coated by a hydrophilic group.

5. The adhesion preventing film according to claim 1, further comprises an intermediate layer formed under the surface layer, wherein a filler is diffused in the intermediate layer.

6. The adhesion preventing film according to claim 1, wherein the protrusion particles are hollow particles having a hollow cavity formed inside.
